(19) United States
(12) Patent Application Publication
(10) Pub. No.: US 2022/0407717 A1
(43) Pub. Date: Dec. 22, 2022

(54) COMPUTER NETWORK APPARATUS

(71) Applicant: Deep Secure Ltd., Malvern (GB)

(72) Inventor: Simon WISEMAN, Malvern (GB)

(73) Assignee: Deep Secure Ltd., Malvern (GB)

(21) Appl. No.: 17/882,243

(22) Filed: Aug. 5, 2022

Related U.S. Application Data
(63) Continuation-in-part of application No. 17/672,224, filed on Feb. 15, 2022.

(30) Foreign Application Priority Data
Feb. 26, 2021 (GB) 2102750.3

(51) Int. Cl. H04L 9/32; H04L 9/08

(52) U.S. Cl. CPC H04L 9/3247; H04L 9/0819

(57) ABSTRACT

A system may include at least one hardware processor implementing a verification unit configured to: receive a set of data from a first computer network; transmit an encrypted version of the set of data to a destination within a second computer network; receive a signature associated with the set of data from the first computer network; verify that the signature is indicative of the set of data being from a known source; and in response to verification of the signature, transmit a decryption key associated with the encrypted version of the set of data to the destination, wherein the destination is configured to decrypt the set of data with the decryption key.

### CROSS-REFERENCE TO RELATED APPLICATIONS

This application is a continuation-in-part of U.S. patent application Ser. No. 17/672,224, filed Feb. 15, 2022, which claims priority to United Kingdom Patent Application Serial No. 2102750.3, filed Feb. 26, 2021, both of which are incorporated by reference herein in their entirety.

### TECHNICAL FIELD

The present disclosure relates to computer network apparatus and method for verifying a set of data transmitting from a first computer network to a second computer network.

### BACKGROUND

Where computer networks handling particularly sensitive information are connected to others, it is often the case that data is only allowed into or out of each computer network if it has been digitally signed by an authorized party. Data without a signature or with an invalid signature is blocked (e.g., it may either be blocked from transmission at a gateway unit of the transmitting computer network, or it may be stopped at a gateway unit of the receiving computer network and not transmitted to the rest of the receiving computer network).

It should be noted that in some situations, the transmitting entity and/or the receiving entity may be individual computers as opposed to computer networks, and they may be coupled to the same network and/or to separate networks. For example, the transmitting entity and the receiving entity may be individual computers that are both coupled to the internet or some other network. Transmissions may be made either from a more-sensitive, higher-security entity to a less-sensitive, lower-security entity, or vice versa. Typically, the higher-security entity performs the verification, thus preventing egress of unsigned data (in the case of the high-security entity transmitting) or preventing reception of unsigned data (in the case of the high-security entity receiving).

Digital signatures are generally applied by calculating some property of the data, typically a hash value, and encrypting this using a private key held by the originator. The encrypted value forms the signature and is transmitted along with the data.

The signature of some data may be validated by decrypting the signature using the public key corresponding to the alleged originator's private key and comparing the result against the value of the property calculated for the received data. If the two values match, the data can be assumed to be unaltered and to have originated with the holder of the private key.

Restricting data that enters a sensitive computer network to data that has been signed by particular trusted parties reduces an attacker's ability to send unsafe data into the computer network, because they must first obtain the private key of one of the trusted parties. Restricting data that leaves a sensitive computer network to data that has been signed by particular trusted parties reduces the scope for information leakage, because data sent in error will not be signed and so will not leave the sensitive computer network.

However, for these restrictions to work properly, none of the data must be allowed to pass until the signature has been verified. If even part of the data were released prior to checking the overall signature, some hostile data could enter or some sensitive data could leave before the signature check blocks the rest, which exposes the receiving computer network to attack and/or the transmitting computer network to information loss. To prevent both information loss and an attack, the signature should be verified at the transmitting computer network before the data is transmitted and/or at the receiving computer network before the data is accepted.

All the data must be stored while the signature is verified. If the signature is valid, the data can then be released. There are two problems with this. First, the device that is validating signatures must have sufficient storage to keep all the data that is in flight at any time. This must be at least the size of the largest possible set of data to be transmitted, but if sets of data are sent in parallel then storage is needed for all of them. The second problem is that storing the set of data and forwarding it once complete introduces latency into the transmission of the data—the receiving computer network has to wait for transmission to the device verifying the signature and then wait for transmission of the data from the device, effectively doubling the latency period.

One solution is to divide the data into a sequence of blocks that are individually signed. However, splitting the set of data into large blocks still means significant storage is needed and latency is increased. To avoid these overheads, the set of data can be split into small blocks. In this case though, computing and storing the signatures themselves carry overheads which become significant. Further, sufficiently small blocks could be rearranged and reused in some cases, effectively allowing for different data to be sent via the reordered blocks while still satisfying the block-by-block signature verification.

Embodiments of the present disclosure seek to overcome these or other disadvantages.

### SUMMARY

According to a first aspect of the present disclosure there is provided a verification unit for a first computer network, the verification unit being operable to receive a set of data, and a signature for the set of data, from the rest of the first computer network, the verification unit comprising;
a. an encryption engine operable to encrypt the received set of data using an encryption key; and
b. a signature checker operable to verify the signature of the set of data;
   wherein the verification unit is operable to transmit the encrypted set of data to a second computer network, and subsequently to transmit the encryption key to the second computer network if the signature is verified.

By encrypting the set of data prior to transmitting it and transmitting the encryption key for the set of data if the signature is verified, the set of data can be sent straight to the second computer network once encrypted and does not need to be stored in the first computer network, being stored instead at the second computer network while verification is carried out. This means that the first computer network does not need storage space for the set of data, but the set of data is still effectively inaccessible to the second computer network given it has been encrypted and cannot be decrypted unless the signature is verified and the encryption key is sent to the second computer network.

According to some embodiments of this disclosure, the storage space required can be spread across the entire system, since the first computer network can send multiple sets of data to different second computer networks while the storage space required at each second computer network need only be the size of the set or sets of data it is receiving (rather than there needing to be one storage space the size of all the sets of data being transmitted to the second computer networks).

Finally, it allows the latency in the set of data being transmitted from the first computer network to the second computer network to be reduced, since the verification unit can transmit the encrypted set of data while still receiving the set of data rather than waiting for receipt of the entire set of data, verifying and then beginning the transmission.

The verification unit may comprise a verification calculator operable to calculate a value of the set of data. The signature checker may be operable to compare the calculated value to the signature so as to verify the signature.

Verification therefore can amount to comparing the calculated value to the signature, a relatively quick form of verification.

The verification unit may be operable to receive a plurality of sets of data concurrently. The verification calculator may be operable to calculate a value of each set of data concurrently. The or each set of data may comprise a header comprising identification information, and a payload comprising the message to be transmitted. The verification calculator may be operable to calculate a value of the payload. Alternatively, the verification calculator may be operable to calculate a value of the payload and the header.

Each set of data may be formed from packets. The verification unit may be operable to receive the packets of the plurality of sets of data interwoven on one stream. The verification calculator may be operable to switch between calculating values for sets of data as packets of different sets of data are received, retaining the previous calculations made for the values of the or each other set of data.

The encryption engine may be operable to encrypt a plurality of sets of data concurrently. The encryption engine may be operable to switch between encrypting sets of data as each packet of a different set of data is received. The encryption engine may be operable to encrypt the packets of the set of data independently of each other. Alternatively, the encryption engine may be operable to encrypt each packet of the set of data such that its encryption is dependent upon the last packet of the set of data.
The encryption engine may be operable to encrypt the payload of the or each set of data or each packet. The encryption engine may be operable to leave the header of the or each set of data or the header of each packet unencrypted.

The signature checker may be operable to decrypt the signature with a decryption key to obtain a decrypted value. The decrypted value may be a property of the signed data. This simplifies the signature, it merely being an encrypted value associated with the set of data.

The signature checker may be operable to compare the decrypted value to the calculated value and verify the signature if the two values match.

The verification unit may comprise a verification memory operable to store one or more decryption keys, wherein the signature checker is operable to use one of the one or more stored decryption keys for decrypting the signature.

Storing one or more decryption keys means the computer network need not send the decryption key for the signature to the verification unit. This means the verification unit can independently verify the signature, since it is not relying on using a decryption key which has been sent to it.

The verification memory may be operable to store a plurality of decryption keys.

Storing a plurality of keys means the verification unit can be used to transmit sets of data from multiple sources (e.g. users or groups of users) within the computer network. This means the verification unit can transmit sets of data for many different users of the computer network, or indeed all the users of a computer network.

The signature checker may be operable to obtain identification information from the set of data to identify a particular decryption key of the plurality of stored decryption keys to use for decrypting the signature.

The ability to obtain identification information from the set of data to identify a particular decryption key means the set of data may comprise identification information identifying which decryption key to use for the signature.

The verification memory may be operable to store a respective identification information with each decryption key. The signature checker may be operable to obtain identification information from the set of data. The signature checker may be operable to compare the obtained identification information to the identification information stored on the verification memory and to identify the decryption key. The signature checker may be operable to identify the decryption key whose respective stored identification information matches the obtained identification information.

Storing respective identification information and using it for identification means the identification information of the set of data can be relatively simple in nature, needing to just match one of the identification information stored and differentiate from the other stored identification information.

The verification memory may be operable to store one or more public keys, wherein the signature checker is operable to use one of the one or more public keys for decrypting the signature.

Storing public keys means the signatures can be encrypted with user's private keys.

The verification calculator may be a verification hasher operable to calculate a hash value.

The verification unit may comprise a key generator operable to generate the encryption key. The key generator may be operable to generate a unique encryption key for each set of data received by the verification unit.

The encryption key being unique to the set of data means prevents the second computer network from decrypting the set of data without the encryption key and using a previously sent or otherwise obtained decryption key, thereby ensuring the received data is inaccessible until the encryption key is released.

The key generator may be operable to transmit the encryption key to the second computer network if the signature is verified. The key generator may be operable to discard the encryption key if the signature is not verified.

By discarding the encryption key if the signature is not verified, the key generator reduces the chances of the encryption key being accidentally sent or otherwise obtained by the second computer network.

The key generator may be operable to delete the encryption key if the signature is not verified.

The verification unit may comprise a verification receiver operable to receive the set of data and the signature. The verification receiver may be operable to receive the set of data as a data stream. The verification receiver may be operable to receive the signature as part of the data stream. The verification unit may be operable to transmit the encrypted set of data as an encrypted data stream.

With the encrypted set of data transmitted as a data stream, the verification unit does not need to wait for the entire set of data to be encrypted before starting transmission.

The verification unit may be operable to stream the set of data through from receipt to transmission.

By streaming the data through from receipt to transmission, the storage space of the verification unit is reduced. Further to this, it reduces latency in the sending of the set of data, since the verification unit does not need to wait for receipt of the entire set of data before starting to transmit it.

The verification unit may be operable to transmit the encrypted set of data concurrently with receiving the set of data. Concurrent receipt and transmission reduces the latency in the second computer network receiving the set of data.

According to a second aspect of the present disclosure there is provided a first computer network comprising a verification unit according to the first aspect and a sender unit operable to transmit the set of data to the verification unit, the sender unit comprising a signature creator operable to create a signature for the set of data, wherein the sender unit is operable to transmit the signature to the verification unit.

By the verification unit encrypting the set of data prior to transmitting it and transmitting the encryption key for the set of data if the signature is verified, the set of data can be sent straight to the second computer network once encrypted and does not need to be stored in the first computer network, being stored instead at the second computer network while verification is carried out. This means that the verification unit of the first computer network does not need storage space for the set of data, but the set of data is still inaccessible to the second computer network given it has been encrypted and cannot be decrypted unless the signature is verified and the encryption key is sent to the second computer network.

According to some embodiments of this disclosure, the storage space required can be spread across the entire system, since the first computer network can send multiple sets of data to different second computer networks while the storage space required at each second computer network need only be the size of the set or sets of data it is receiving (rather than there needing to be one storage space the size of all the sets of data being transmitted to the second computer networks).

Finally, it allows the latency in the set of data being transmitted from the first computer network to the second computer network to be reduced, since the verification can transmit the encrypted set of data while still receiving the set of data rather than waiting for receipt of the entire set of data, verifying and then beginning the transmission.

The second aspect may comprise any of the optional features of the first aspect, as desired or appropriate.

The sender unit may comprise a sender calculator operable to calculate a value of the set of data. The signature creator may be operable to encrypt the calculated value with a signing key to form the signature.

This means verifying the signature is a relatively simple matter of decrypting the value and comparing it to the same value calculated by the verification unit.

The sender calculator may be a sender hasher operable to calculate a hash value.

The sender unit may be operable to receive a plurality of sets of data concurrently. The sender calculator may be operable to calculate a value of each set of data concurrently. The sender calculator may be operable to calculate a value of the payload. Alternatively, the verification calculator may be operable to calculate a value of the payload and the header.

The sender unit may be operable to receive the packets of the plurality of sets of data interwoven on one stream. The sender calculator may be operable to switch between calculating values for sets of data as packets of different sets of data are received, retaining the previous calculations made for the values of the or each other set of data.

The sender unit may be operable to trigger the signature creator to start the encryption once the entire set of data has been transmitted to the verification unit.

The signature creator may be operable to transmit the created signature to the verification unit.

The sender unit may be operable to create the set of data. The sender unit may be operable to receive the set of data.

By being operable to receive the set of data, the sender unit may act as a signing centre for one or more users of a computer network, more efficiently signing multiple sets of data than each user signing their own.

The sender unit may be operable to transmit the set of data as a data stream. The sender unit may be operable to receive the set of data as a data stream. The sender unit may be operable to stream the set of data through from receipt to transmission.

By streaming the data through from receipt to transmission, the sender unit does not need to temporarily store any of the set of data. Further to this, it reduces latency in the sending of the set of data, since the sender unit does not need to wait for receipt of the entire set of data before starting to transmit it.

The sender unit may be operable to transmit the set of data concurrently with receiving the set of data. Concurrent receipt and transmission reduces the latency in the second computer network receiving the set of data.

The sender unit may be operable to incorporate the signature into the data stream. The sender unit may be operable to incorporate the signature as the end of the data stream.

By incorporating the signature into the data stream, there is a clear association between the signature and the set of data when they reach the verification unit. By incorporating the signature as the end of the data stream, beginning transmission of the set of data does not need to wait for creation of the signature.

The sender unit may comprise sender memory operable to store one or more signing keys. Storing one or more signing keys means the computer network need not send the signing key for the signature to the sender unit. This means the sender unit is not relying on using a signing key which has been sent to it, which could be a fake.

The sender memory may be operable to store a plurality of signing keys.

Storing a plurality of keys means the sender unit can be used to sign sets of data from multiple sources (e.g. users or groups of users) within the computer network. This means the sender unit can sign sets of data for many different users of the computer network, or indeed all the users of a computer network.

The signature creator may be operable to identify a particular signing key of the plurality of stored decryption keys to use for creating the signature.

The ability to identify a particular signing key means the set of data may comprise identification information identifying which signing key to use for the signature.

The sender memory may be operable to store a respective identification information with each signing key. The signature creator may be operable to obtain identification information from the set of data. The signature creator may be operable to compare the obtained identification information to the identification information stored on the sender memory and to identify the signing key. The signature creator may be operable to identify the signing key whose respective stored identification information matches the obtained identification information.

Storing respective identification information and using it for identification means the identification information of the set of data can be relatively simple in nature, needing to just match one of the identification information stored and differentiate from the other stored identification information.

The sender memory may be operable to store a private key, and the signature creator may be operable to use a private key to encrypt the signature.

According to a third aspect of the present disclosure there is provided a system of computer networks comprising the first computer network according to the second aspect and the second computer network, the second computer network comprising a gateway unit operable to receive the encrypted set of data and encryption key from the verification unit of the first computer network, the gateway unit comprising:

a. a buffer operable to store the encrypted set of data; and

b. a decryption engine operable to decrypt the set of data using the encryption key.

By encrypting the set of data prior to transmitting it and transmitting the encryption key for the set of data if the signature is verified, the set of data can be sent straight to the second computer network once encrypted and does not need to be stored in the first computer network, being stored instead at the second computer network while verification is carried out. This means that the first computer network does not need storage space for the set of data, but the set of data is still secure given it has been encrypted and cannot be decrypted unless the signature is verified and the encryption key is sent to the second computer network.

According to some embodiments of this disclosure, the storage space required can be spread across the entire system, since the first computer network can send multiple sets of data to different second computer networks while the storage space required at each second computer network need only be the size of the set or sets of data it is receiving (rather than there needing to be one storage space the size of all the sets of data being transmitted to the second computer networks).

Finally, it allows the latency in the set of data being transmitted from the first computer network to the second computer network to be reduced, since the verification can transmit the encrypted set of data while still receiving the set of data rather than waiting for receipt of the entire set of data, verifying and then beginning the transmission.

The third aspect may comprise any of the optional features of the second aspect, as desired or appropriate.

The gateway unit may be operable to receive the set of data as a data stream.

With the gateway unit operable to receive the encrypted set of data as a data stream, the verification unit does not need to wait for the entire set of data to be encrypted before starting transmission.

The gateway unit may be operable to transmit the decrypted set of data to the rest of the second computer network.

According to a fourth aspect of the present disclosure, there is provided a method of verifying a set of data for transmission from a first computer network to a second computer network, the method comprising the steps of:
a) receiving the set of data;
b) encrypting the set of data with an encryption key;
c) transmitting the encrypted set of data to the second computer network;
d) verifying a signature of the set of data; and
e) transmitting the encryption key to the second computer network if the signature is verified.

By encrypting the set of data prior to transmitting it and transmitting the encryption key for the set of data if the signature is verified, the set of data can be sent straight to the second computer network once encrypted and does not need to be stored in the first computer network, being stored instead at the second computer network while verification is carried out. This means that the first computer network does not need storage space for the set of data, but the set of data is still not accessible to the second computer network given it has been encrypted and cannot be decrypted unless the signature is verified and the encryption key is sent to the second computer network.

According to some embodiments of this disclosure, the storage space required can be spread across the entire system, since the first computer network can send multiple sets of data to different second computer networks while the storage space required at each second computer network need only be the size of the set or sets of data it is receiving (rather than there needing to be one storage space the size of all the sets of data being transmitted to the second computer networks).

Finally, it allows the latency in the set of data being transmitted from the first computer network to the second computer network to be reduced, since the verification can transmit the encrypted set of data while still receiving the set of data rather than waiting for receipt of the entire set of data, verifying and then beginning the transmission.

The method may comprise the step of calculating a value of the set of data. Verifying the signature may comprise decrypting the signature with a decryption key to obtain a value and comparing the decrypted value with the calculated value. This allows the signature to just be an encrypted value associated with the data, which allows the simple comparison for verification while also preventing the signature from being tampered with.

The calculated value and the decrypted value may be hash values.

The decryption key may be a public key.

The method may comprise the step of storing the transmitted encrypted set of data.

The method may comprise the step of decrypting the stored encrypted set of data with the transmitted encryption key.

The set of data may be transmitted as a data stream. By transmitting the encrypted set of data as a data stream, there is no need to wait for the entire set of data to be encrypted before starting transmission.

The set of data may be transmitted concurrently with receiving the set of data. Concurrent receipt and transmission reduces the latency in the second computer network receiving the set of data.

The method may comprise the step of creating the encryption key. The method may comprise the step of creating a unique encryption key for the set of data.

The encryption key being unique to the set of data means prevents the second computer network from decrypting the set of data without the encryption key and using a previously sent or otherwise obtained decryption key, thereby keeping the method secure.

### BRIEF DESCRIPTION OF THE DRAWINGS

In order that the disclosure may be more clearly understood one or more embodiments thereof will now be described, by way of example only, with reference to the accompanying drawing:

FIG. 1 shows a system of a transmitting computer network and a receiving computer network;

FIG. 2 shows a second embodiment of a system of a transmitting computer network and a receiving computer network; and

FIG. 3 shows a third embodiment of a system of a transmitting computer network and a receiving computer network.

### DETAILED DESCRIPTION

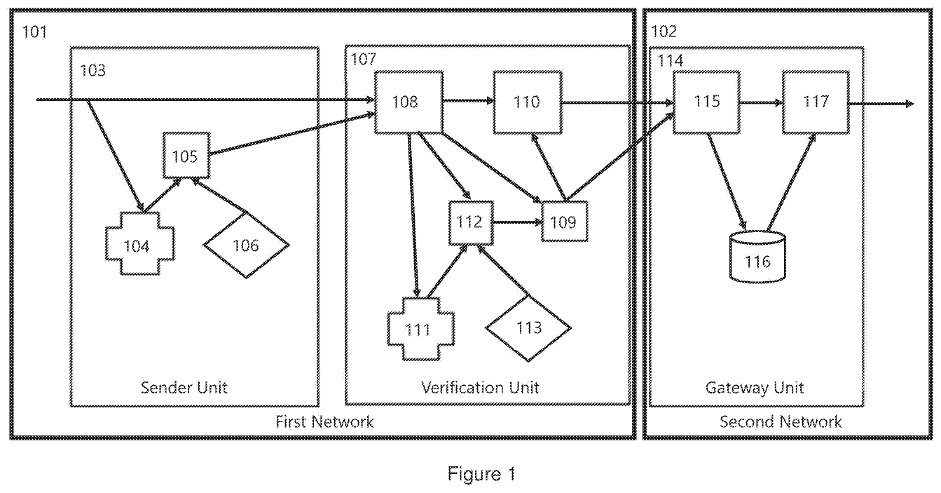

FIG. 1 shows a first computer network 101, the computer network which is transmitting data, and a second computer network 102, the computer network which is receiving the data. The first computer network comprises a sender unit 103 and a verification unit 107, while the second computer network 102 comprises a gateway unit 114.

The sender unit 103 comprises a sender hasher 104, a signature creator 105 and a sender memory 106. The sender unit 103, upon receipt of the data stream sent by a user, passes it through and transmits it to the verification unit 107 of the first computer network 101. At the same time, it copies the data stream to the sender hasher 104. The sender hasher 104 calculates the hash value of the set of data.

The set of data may include a header comprising identifying information for the message to be transmitted and a payload comprising the message. In some embodiments the sender hasher 104 calculates the hash value of the payload and the header. In other embodiments, the sender hasher 104 calculates the hash value of only the payload.

Once the entire set of data has been transmitted to the verification unit 107, the sender unit 103 triggers the signature creator 105. The signature creator 105 reads the hash value from the sender hasher 104, and reads a signing key (e.g. the private key for authorized transmissions) stored on the sender memory 106. The signature creator 105 encrypts the hash value using the signing key to create a signature for the set of data. The signature is then transmitted to the verification unit 107, as the end of the data stream.

The verification unit 107 comprises a verification receiver 108, a key generator 109, an encryption engine 110, a verification hasher 111, a signature verifier 112, and a verification memory 113. The verification receiver 108 receives the data stream from the sender unit 103.

Once it starts to receive the data stream, the verification unit 107 triggers the key generator 109 to generate an encryption key. The generated encryption key is transmitted to the encryption engine 110, and then the verification receiver 108 passes the data stream through to the encryption engine 110. The encryption engine 110 encrypts the data stream using the encryption key. As each part of the data stream is encrypted it is transmitted to the gateway unit 114 of the second computer network 102.

In one embodiment, the encryption engine 110 encrypts only the payload of the set of data, leaving the header unencrypted.

The verification receiver 108 also copies the data stream to the verification hasher 111. Once the verification hasher 111 has received the entire data stream it calculates the hash value of the set of data. The verification hasher 111 calculates the same hash value as the sender hasher 104 (either the hash value of the payload and the header or the hash value of just the payload).

Once the entire set of data has been received by the verification receiver 108 and the signature is received as the end of the data stream, the verification receiver 108 transmits the signature to the signature verifier 112. The signature verifier 112 reads the hash value from the verification hasher 111 and a decryption key (e.g. the public key corresponding to the private key for authorized transmits) from the verification memory 113. The signature verifier 112 uses the decryption key to decrypt the signature and compares the decrypted signature to the hash value calculated by the verification hasher 111. The decrypted signature matching the hash value means the correct private key was used to create the signature and the set of data has not been modified since the signature was created, and so the signature is valid. If the two values do not match, then either the wrong private key was used for the signature or the set of data has been modified since the signatures creation. In either case, the signature is invalid.

If the signature verifier 112 verifies that the signature is valid, it communicates that the signature is valid to the key generator 109. The key generator 109 then transmits the encryption key to the gateway unit 114 of the second computer network 102.

If the signature verifier 112 does not verify the signature, the encryption key is not transmitted to the gateway unit 114 and is instead discarded.

The gateway unit 114 comprises a gateway receiver 115, a buffer 116 and a decryption engine 117. The encrypted data stream is received at the gateway receiver 115, which transmits each part of the encrypted set of data to the buffer 116 for storage as each part is received.

The gateway receiver 115 also receives the encryption key, assuming the signature has been verified. Once the encryption key has been received it is transmitted to the decryption engine 117. The decryption engine 117 then pulls the set of data from the buffer 116 and uses the encryption key to decrypt it. Once the set of data is decrypted, it is transmitted as a data stream to the appropriate address in the second computer network.

If the signature is not verified, the encryption key is never sent to the receiver unit 114. Accordingly, the encrypted set of data is not (and, given the encryption key was discarded, cannot ever be) decrypted. This means no sensitive information is lost by the transmission of the set of data, and any attack via the transmission is prevented.

As such, in use the data stream passes through the sender unit and verification unit, the set of data not been stored in either. For both units, transmission of the set of data from each unit starts almost instantaneously upon the unit starting to receive the data stream, such that the acts of receipt of the set of data at, and transmission of the set of data from, each unit are concurrent. The set of data is only stored once it reaches the gateway unit of the second computer network.

In some embodiments the verification memory can store multiple decryption keys. Each decryption key will be stored with identification information such as an associated address. The verification receiver will read the address in the set of data which indicates from where in the first computer network it has been sent, and transmit this address to the signature verifier 112. The signature verifier 112 will then select the decryption key for use whose associated address matches the read address. In this way the verification unit can verify the signatures of multiple different private keys used in the first computer network, allowing the verification unit to verify the signatures of multiple different users (or groups of users if the users of a group all use the same private key, for example a department in an organisation). The verification unit can act as a verification hub for an entire first computer network where multiple private keys are used across the computer network.

In some embodiments the sender memory can store multiple signing keys, each signing key stored with an associated address. The sender unit will read the address in the set of data which indicates from where in the first computer network it has been sent, and transmit this address to the signature creator 105. The signature creator 105 will then use this read address to choose the correct signing key for the encryption of the hash value, choosing the signing key whose associated address matches the read address. This allows the sender unit to act as a signing hub for multiple users (or groups of users) on the first computer network.

The sender unit 103 and verification unit 107 can process multiple sets of data concurrently. In some embodiments, the sender unit 103 can receive each set of data from a respective channel to the sender unit 103. The sender hasher 104 and verification hasher 111 calculate hash values for each set of data in parallel. The key generator 109 generates a unique encryption key for each set of data, and the encryption engine 110 encrypts each set of data with the respective encryption key in parallel.

In other embodiments, the sender unit 103 receives multiple sets of data from one channel, each set of data split into packets and the packets interwoven on the channel. Each packet comprises a payload comprising part of the message to be transmitted and a header comprising identifying information. The header of each packet comprises an identification which associates all the packets which form the set of data, and a number which identifies the order of the packets of the set of data.

In some embodiments the last packet of the set of data may comprise an “end of message” flag in its header. In other embodiments, the first packet may include information in its header which identifies the length of the message.

The sender hasher 104 and the verification hasher 111 may switch between calculating different hash values for different sets of data as different packets of each set of data are received, keeping track of the sections of each hash value already calculated for the other sets of data and reverting back to calculating them when the next packet of the relevant set of data is received.

The signature creator 105 may incorporate the created signature into the last packet of the respective set of data. In many embodiments this means adding it onto the end of the last packet. If the first packet included information in its header which identifies the length of the message, the verifier 107 will modify this information before transmitting the first packet on to account for the signature which is to be added.

In some embodiments the encryption engine 110 encrypts each packet of a set of data independently of the others. In other embodiments, the encryption of one packet feeds into the encryption of the next in the set of data (i.e. cipher block chaining).

In some embodiments, encryption keys may be generated periodically (e.g., once per message) in order to prevent reuse. In one embodiment, sender unit 103 may transmit an encryption key to verification unit 107 (e.g., at the beginning of a message). Verification unit 107 may then use the encryption key to encrypt the message, retaining the key until the signature has been verified, at which point it may be transmitted to second network 102.

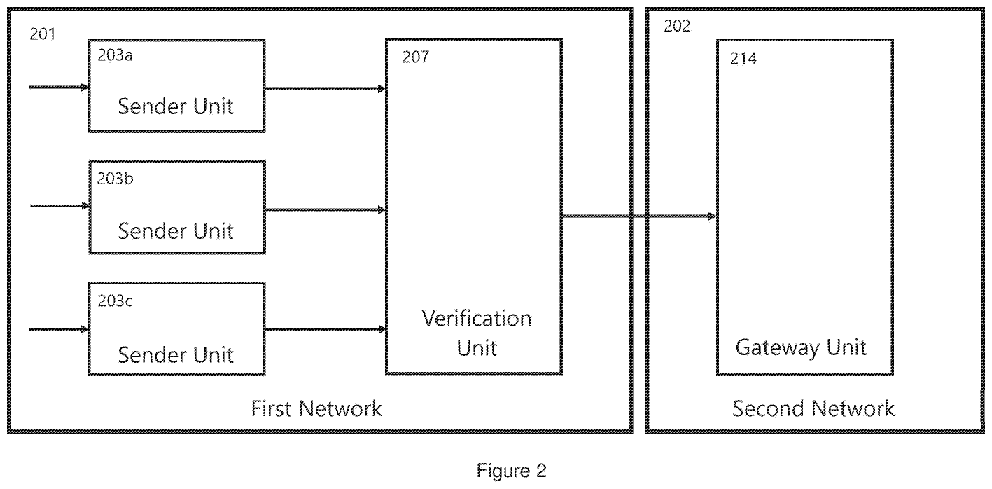

In the embodiment shown in FIG. 2 the transmitting computer network 201 has a plurality of sender units 203a, 203b, 203c. Each sender unit 203a, 203b, 203c has a respective channel via which is receives a respective set of data. Each sender unit 203a, 203b, 203c creates and incorporates a signature into the respective set of data and transfers their set of data to the verification unit 207, which receives the sets of data concurrently. The verification unit 207 calculates the hash values of each set of data and encrypts the sets of data in parallel, and concurrently transfers the sets of data and respective encryption keys to the gateway unit 214 of the second computer network 202.

In other embodiments the system may comprise a plurality of second networks 202, and the verification unit 207 transfers one or more of the sets of data and respective encryption keys to different second networks 202.

The embodiments of FIGS. 1 and 2 (in which the verification unit is a part of the first network which transmits the data) may be most suited for the situation of transmitting information from a high-security first network to a low-security second network. As discussed above, however, in some embodiments, information may be transmitted from a low-security first network to a high-security second network. In some of such embodiments, the verification unit may be located in the second network.

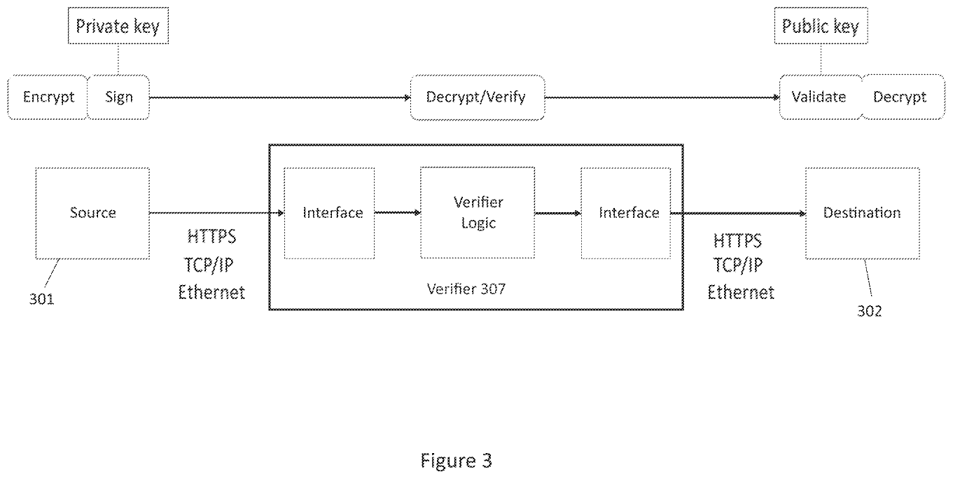

FIG. 3 illustrates an embodiment in which a source 301 transmits information to a destination 302 via a verifier 307. In the embodiment of FIG. 3, verifier 307 may be an element of the source network or the destination network, as desired.

For example, in one embodiment for transmitting information from a low-security first network to a high-security second network, a trusted originator within the low-security source network may encrypt the information with a key that may be generated for the purpose. In one embodiment, the data may be encrypted with a symmetric encryption key. In another embodiment, the data may be encrypted with the private key of an asymmetric key pair. The encrypted form of the data may then be signed with a private key. The encrypted data may then be transmitted, followed by the signature and the decryption key. (For example, the decryption key may be the same as the encryption key in the case of symmetric encryption, or it may be a private key corresponding to the public encryption key in the case of asymmetric encryption.) The encrypted data may be transmitted in parallel with the signature as it is being created in some embodiments.

Encrypting the data may cause it to become effectively indistinguishable from random data that cannot be interpreted or executed, and thus it cannot trigger unwanted behavior at destination 302. In particular, the encrypted data cannot induce predictable unsafe behaviour in the software that may handle it, and so it cannot be used in an attack. Compressing the data is another means of achieving the same end.

Verifier 307 may store the encrypted data upon receipt and proceed to validate the signature. The signature may be validated in parallel with receipt of the data in some implementations, although typically the validity will be known only at the end of this process. If the signature is invalid, the encryption key and encrypted data may be discarded. If the signature is valid, the decryption key may be used to decrypt the data prior to its use.

In some situations, this arrangement on its own may not stop an attacker from submitting un-encrypted unsafe data. Accordingly, in some embodiments an independent verifier may be employed, placed to receive all data passing into the high-security domain, confirming that the data is indeed encrypted. To do this, the verifier may have the decryption key, and the data may have some identifiable structure that the verifier can look for. In these and other embodiments, the verifier itself may encrypt the data before proceeding.

Accordingly, source 301 may include the symmetric encryption key at the start of the data. Verifier 307 may then use this key to decrypt the data for inspection, and it may retain the key until the end of the data before passing it to the receiver. To structure the data, a chunked encoding may be used in some implementations. This structures the data as a sequence of small, counted blocks of bytes. This structure will generally not be apparent if unencrypted data is decrypted, and so an attacker cannot present unsafe data of their choosing, as it would be rejected by the verifier.

In particular, this embodiment leverages the encryption of potentially unsafe data to render it inert. The use of encryption allows the signature of released data to be verified as a stream, by rendering the data (temporarily) unreadable until after the signature has been verified. Further, the signature on the data may be validated in a gateway such as verifier 307, which then encrypts the stream as it forwards it. Once the end of the stream is reached, the signature is finally validated, and if valid, the gateway may forward the encryption key so the data can be unlocked.

In some embodiments, source 301 may sign the data and allow the gateway to encrypt it after verification, releasing the encryption key after the signature is validated. This may require the gateway to handle the public key cryptography used in digital signatures, including managing the keys.

However, in other embodiments, the source 301 itself may encrypt the data, and it may do so before signing it. Destination 302 may then be responsible for validating the signature. With this arrangement, the gateway need only decrypt/decompress the data as it streams through. In this embodiment, no key management is needed at the gateway. Further, it also means that the gateway can support multiple source/destination feeds.

In some embodiments, the gateway need not store the incoming data while it validates the signature. Rather, it may encrypt the data (e.g., with a newly generated key) and pass it on. Thus only after the signature has been validated, after all the data has been received, the gateway may pass on the key. This arrangement obviates the need for the gateway to store the full amount of data that is in flight at any given time.

As will be appreciated by one of ordinary skill in the art with the benefit of this disclosure, one or more elements according to this disclosure may be implemented as hardware, software, and/or firmware. For example, a verifier (or any other suitable element) may comprise a computer system including physical storage media, one or more processors, a memory, a BIOS, a network interface, etc. In other embodiments, a verifier may be implemented as other circuitry (e.g., one or more application-specific integrated circuits (ASICs), microcontrollers, discrete logic gates, etc.). For purposes of this disclosure, the term “hardware processor” encompasses all of these implementations.

The one or more embodiments are described above by way of example only. Many variations are possible without departing from the scope of protection afforded by the appended claims.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. A system comprising:
at least one hardware processor implementing a verification unit configured to:
receive a set of data from a first computer network;
transmit an encrypted version of the set of data to a destination within a second computer network;
receive a signature associated with the set of data from the first computer network;
verify that the signature is indicative of the set of data being from a known source; and
in response to verification of the signature, transmit a decryption key associated with the encrypted version of the set of data to the destination, wherein the destination is configured to decrypt the set of data with the decryption key.

2. The system of claim 1, further configured to, in response to a failed verification of the signature, discard the decryption key.

3. The system of claim 1, wherein the encryption key is associated with a symmetric encryption algorithm.

4. The system of claim 1, wherein the encryption key is associated with an asymmetric encryption algorithm.

5. The system of claim 1, wherein the set of data received from the first computer network is the encrypted version of the set of data, and wherein the decryption key is received from the first computer network.

6. The system of claim 1, further configured to: in response to a determination that the set of data received from the first computer network is not encrypted, encrypt the set of data to generate the encrypted version of the set of data.

7. The system of claim 1, wherein the first computer network is the internet.

8. A method comprising:
receiving a set of data from a first computer network;
transmitting an encrypted version of the set of data to a destination within a second computer network;
receiving a signature associated with the set of data from the first computer network;
verifying that the signature is indicative of the set of data being from a known source; and
in response to verification of the signature, transmitting a decryption key associated with the encrypted version of the set of data to the destination, wherein the destination is configured to decrypt the set of data with the decryption key.

9. The method of claim 8, further comprising, in response to a failed verification of the signature, discarding the decryption key.

10. The method of claim 8, wherein the encryption key is associated with a symmetric encryption algorithm.

11. The method of claim 8, wherein the encryption key is associated with an asymmetric encryption algorithm.

12. The method of claim 8, wherein the decryption key is received from the first computer network.

13. The method of claim 8, further comprising: in response to a determination that the set of data received from the first computer network is not encrypted, encrypt the set of data to generate the encrypted version of the set of data.

14. The method of claim 8, wherein the first computer network is the internet.

15. An article of manufacture comprising a non-transitory, computer-readable medium having instructions coded thereon that are executable by at least one hardware processor for:
receiving a set of data from a first computer network;
transmitting an encrypted version of the set of data to a destination within a second computer network;
receiving a signature associated with the set of data from the first computer network;
verifying that the signature is indicative of the set of data being from a known source; and
in response to verification of the signature, transmitting a decryption key associated with the encrypted version of the set of data to the destination, wherein the destination is configured to decrypt the set of data with the decryption key.

16. The article of claim 15, wherein the instructions are further executable for, in response to a failed verification of the signature, discard the decryption key.

17. The article of claim 15, wherein the encryption key is associated with a symmetric encryption algorithm.

18. The article of claim 15, wherein the encryption key is associated with an asymmetric encryption algorithm.

19. The article of claim 15, wherein the decryption key is received from the first computer network.

20. The article of claim 15, wherein the instructions are further executable for: in response to a determination that the set of data received from the first computer network is not encrypted, encrypt the set of data to generate the encrypted version of the set of data.
